(19) United States
(12) Patent Application Publication
(10) Pub. No.: US 2010/0115319 A1
(43) Pub. Date: May 6, 2010

(54) STORING DEVICE AND ELECTRONIC DEVICE HAVING THE SAME

(75) Inventor: YI-TA CHIANG-LIN, Tu-Cheng (TW)

Correspondence Address: PCE INDUSTRY, INC.;ATT. Steven Reiss, 288 SOUTH MAYO AVENUE, CITY OF INDUSTRY, CA, 91789, US

(73) Assignee: HON HAI PRECISION INDUSTRY CO., LTD., Tu-Cheng (TW)

(21) Appl. No.: 12/413,590

(22) Filed: Mar. 29, 2009

(30) Foreign Application Priority Data
Oct. 30, 2008 (CN) 200810305299.6

(51) Int. Cl. G06F 1/32; G06F 1/26; G06F 12/00; G06F 12/02

(52) U.S. Cl. 713/324; 713/300; 711/115; 711/112; 711/103; 711/E12.001; 711/E12.008

(57) ABSTRACT

A storing device includes a number of first storing unit, a second storing unit, and a control unit. The first storing units are capable of storing files therein. The second storing unit is capable of storing address information corresponding to the files stored in the first storing units. The control unit is electrically connected to each first storing unit and the second storing unit respectively. The control unit includes a data interface for communicating data with each first storing unit and a power port. The control unit is capable of selectively providing power for the first storing unit.

### BACKGROUND

1. Technical Field

The present disclosure relates to data storage technology and, particularly, to an energy-saving storing device and an electronic device having the same.

2. Description of the Related Art

A typical just a bunch of disks (JBOD) usually includes a digital signal processing (DSP) chip and a number of disks. The capacity of the JBOD is substantially equal to the sum of the capacity of the number of disks. Such that, a storing device with large capacity can be produced by using the JBOD technology. However, in the typical JBOD, the address information of files storied in each disk is storied in corresponding disk, all disks of the JBOD need be powered on when reading or writing data from or into the JBOD. As a result, the energy consumption of the JBOD increases greatly with the increase of the number of the disks.

What is needed, therefore, is an energy-saving storing device with big capacity to overcome the above-described problems.

### BRIEF DESCRIPTION OF THE DRAWING

Many aspects of the present storing device and electronic device can be better understood with reference to the accompanying drawings. The components in the drawing are not necessarily drawn to scale, the emphasis instead being placed upon clearly illustrating the principles of the present storing device and electronic device.

FIG. 1 is a functional block diagram of an electronic device including a storing device according to an exemplary embodiment.

FIG. 2 is a functional block diagram of a control unit of the storing device of the electronic device of FIG. 1.

### DETAILED DESCRIPTION OF THE EMBODIMENTS

Embodiments of the present disclosure will now be described in detail below, with reference to the accompanying drawing.

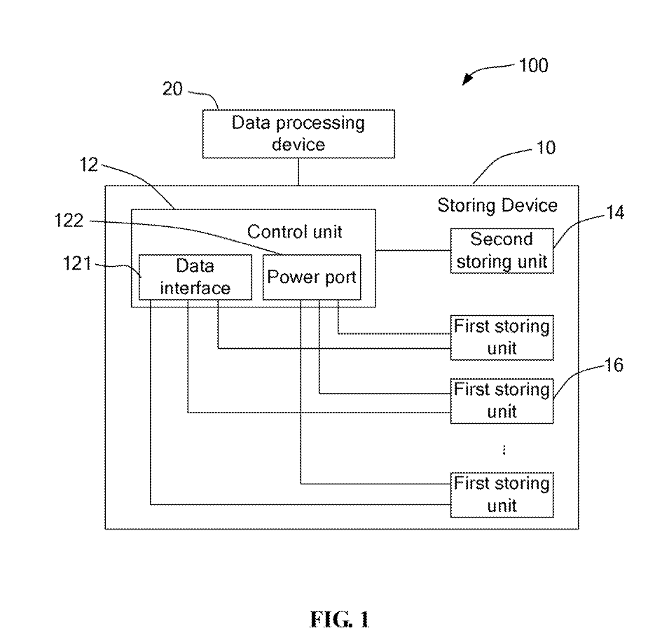

Referring to FIG. 1, an electronic device 100 includes a storing device 10 and a data processing device 20. The data processing device 20 is electronically connected to the storing device 10, and reading or writing data from or into the storing device 10. The data processing device 20 can be a computer or a server.

The storing device 10 includes a control unit 12, a number of first storing units 16, and a second storing unit 14.

The control unit 12 is electrically connected to the second storing unit 14 and the first storing units 16. The control unit 12 includes a data interface 121 and a power port 122. The control unit 12 can read/write data from/into each first storing unit 16 via the data interface 121, and can selectively supply power for one or more first storing units 16 via the power port 122. The data interface 121 can be a small computer system interface (SCSI), a universal serial bus (USB) interface, or a network interface. The type of the data interface 121 used by the control unit 12 is determined by the type of the first storing units 16. The first storing units 16 are configured for storing files therein. In the present embodiment, the first storing units 16 are hard disks and the data interface 121 is SCSI. Preferably, each first storing unit 16 is detachable from the storing device 10.

The second storing unit 14 is configured for storing address information corresponding to the files stored in the first storing units 16. The address information includes BIOS parameter block (BPB), file allocation table (FAT), physical addresses, logical addresses and etc. The second storing unit 14 can be a hard disk, a secure digital memory card, or a mini secure digital memory card and etc. Preferably, the second storing unit 14 is detachable from the storing device 10. The second storing unit 14 can also be used for storing driving program of the storing device 10.

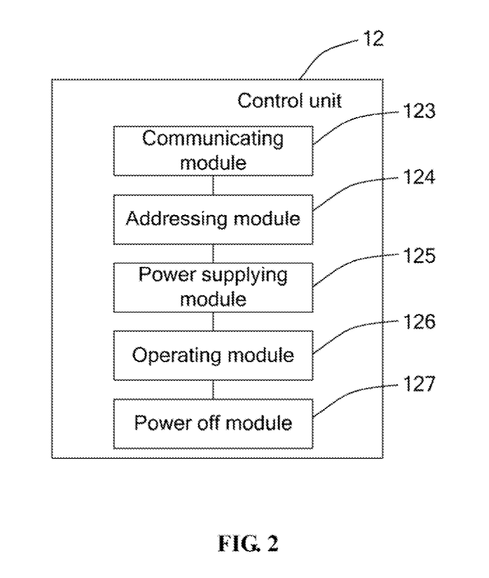

Referring to FIG. 2, the control unit 12 further includes a communicating module 123, an addressing module 124, a power supplying module 125, and an operating module 126.

The communicating module 123 is configured for receiving a read/write request from the data processing device 20.

The addressing module 124 is configured for searching addresses of files to be read, or empty spaces to store files according to the address information stored in the second storing unit 14. The addressing module 124 will search addresses of files to be read during a read operation, and searching addresses of empty spaces to store files during a write operation.

The power supplying module 125 is configured for powering on each first storing unit 16 to be used in the read or write operations. The first storing unit 16 which stores the files to be read out or has empty spaces to store files is the storing unit 16 to be used.

The operating module 126 is configured for reading/writing files from/into the first storing unit 16.

The control unit 12 can further includes a power off module 127. The power off module 127 is configured for powering off a first storing unit 16, if the first storing unit 16 has not been used for a predetermined time.

In the storing device 10, because the address information is stored in the second storing unit 14, the first storing units 16 don't need be powered on during the addressing process of the storing device 10. Therefore, the storing device 10 can selectively provide power to the first storing units 16 which will be used. Accordingly, the storing device 10 can achieve energy-saving.

While certain embodiments have been described and exemplified above, various other embodiments will be apparent to those skilled in the art from the foregoing disclosure. The present invention is not limited to the particular embodiments described and exemplified, and the embodiments are capable of considerable variation and modification without departure from the scope of the appended claims.

What is claimed is:

1. A storing device comprising:
a plurality of first storing units capable of storing files therein;
a second storing unit capable of storing address information corresponding to the files stored in the first storing units; and
a control unit electrically connected to each first storing unit and the second storing unit, respectively, the control unit comprising a data interface for communicating data with each first storing unit, and a power port, the control unit being capable of selectively providing power for the first storing unit via the power port.

2. The storing device as claimed in claim 1, wherein each of the first storing units is detachable from the storing device.

3. The storing device as claimed in claim 1, wherein the second storing unit is detachable from the storing device.

4. The storing device as claimed in claim 1, wherein the first storing units are hard disks.

5. The storing device as claimed in claim 1, wherein the second storing unit is a hard disk, a Secure Digital Memory Card, or a Mini Secure Digital Memory Card.

6. The storing device as claimed in claim 1, wherein the second storing unit is further used for storing driving program of the storing device.

7. The storing device as claimed in claim 1, wherein the data interface is a Small Computer System Interface, a Universal Serial Bus interface, or a network interface.

8. The storing device as claimed in claim 1, wherein the control unit further comprises:
a communicating module configured for receiving a read/write request from a data processing device;
an addressing module configured for searching addresses of files to be read out, or empty spaces to store files according to the address information stored in the second storing unit;
a power supplying module configured for powering on each first storing unit to be used; and
an operating module configured for reading/writing files from/into the first storing units.

9. The storing device as claimed in claim 8, wherein the control unit further comprises a power off module configured for powering off a first storing unit, if the first storing unit has not been used for a predetermined time.

10. An electronic device comprising:
a data processing device; and
a storing device, the storing device comprising:
a plurality of first storing units capable of storing files therein;
a second storing unit capable of storing address information corresponding to the files stored in the first storing units; and
a control unit electrically connected to each first storing unit and the second storing unit respectively, the control unit comprising a data interface for communicating data with each first storing unit and a power port, the control unit being capable of selectively providing power for the first storing unit via the power port.

11. The electronic device as claimed in claim 10, wherein the data processing device is a computer or a server.

12. The electronic device as claimed in claim 10, wherein each of the first storing units is detachable from the storing device.

13. The electronic device as claimed in claim 10, wherein the second storing unit is detachable from the storing device.

14. The electronic device as claimed in claim 10, wherein the first storing units are hard disks.

15. The electronic device as claimed in claim 10, wherein the second storing unit is a hard disk, a Secure Digital Memory Card, or a Mini Secure Digital Memory Card.

16. The electronic device as claimed in claim 10, wherein the second storing unit is further used for storing driving program of the storing device.

17. The electronic device as claimed in claim 10, wherein the data interface is a Small Computer System Interface, a Universal Serial Bus interface, or a network interface.

18. The electronic device as claimed in claim 10, wherein the control unit further comprises:
a communicating module configured for receiving a read/write request from a data processing device;
an addressing module configured for searching addresses of files to be read out, or empty spaces to store files according to the address information stored in the second storing unit;
a power supplying module configured for powering on each first storing unit to be used; and
an operating module configured for reading/writing files from/into the first storing units.

19. The electronic device as claimed in claim 18, wherein the control unit further comprises a power off module configured for powering off a first storing unit, if the first storing unit has not been used for a predetermined time.
